(19) United States
(12) Patent Application Publication
(10) Pub. No.: US 2011/0096784 A1
(43) Pub. Date: Apr. 28, 2011

(54) Controlled Propagation of VLAN Declarations

(75) Inventor: Aravindan Ramalingam, Bangalore (IN)

(73) Assignee: Cisco Technology, Inc., a corporation of California, San Jose, CA (US)

(21) Appl. No.: 12/634,030

(22) Filed: Dec. 9, 2009

(30) Foreign Application Priority Data
Oct. 27, 2009 (IN) 2223/DEL/2009

(51) Int. Cl. H04L 12/56

(52) U.S. Cl. 370/395.53

(57) ABSTRACT

The propagation of virtual local area network (VLAN) declarations is controlled, to minimize or eliminate their propagation to packet switching devices which do not carry traffic for a corresponding VLAN. Initially and in response to a first time receipt of a VLAN declaration for a particular VLAN on a particular interface of a packet switching device, VLAN declarations for the particular VLAN is propagated out every interface of the packet switching device. After a predetermined time frame, if a VLAN declaration has not been received on a particular interface for an active VLAN, propagation of the VLAN declarations for the active VLAN will be suppressed for the particular interface.

### TECHNICAL FIELD

The present disclosure relates generally to communications systems.

### BACKGROUND

The communications industry is rapidly changing to adjust to emerging technologies and ever increasing customer demand. This customer demand for new applications and increased performance of existing applications is driving communications network and system providers to employ networks and systems having greater speed and capacity (e.g., greater bandwidth). In trying to achieve these goals, a common approach taken by many communications providers is to use packet switching technology.

A virtual local area network (LAN), commonly known as a VLAN, is a group of hosts with a common set of requirements that communicate as if they were attached to the broadcast domain, regardless of their physical location. A VLAN has the same attributes as a physical LAN, but it allows for end stations to be grouped together even if they are not located on the same network switch.

Configuration of VLANs can be a complex task. Multiple VLAN Registration Protocol (MVRP) is used to ease this burden, as it is a standards-based Layer 2 network protocol for automatic configuration of VLAN information on switches. Within a Layer 2 network, MVRP provides a method to dynamically share VLAN information and configure the needed VLANs. For example, in order to add a switch port to a VLAN, only the end port, or the VLAN-supporting network device connected to the port, needs to be reconfigured, and all necessary VLAN trunks are dynamically created on the other MVRP-enabled switches. Without MVRP, (or the similar Cisco-proprietary protocol VTP) manual configuration of VLAN trunks is necessary.

### BRIEF DESCRIPTION OF THE DRAWINGS

The appended claims set forth the features of the invention with particularity. The invention, together with its advantages, may be best understood from the following detailed description taken in conjunction with the accompanying drawings of which:

FIG. 1A illustrates an example network operating according to one embodiment;

FIG. 1B illustrates an example network operating according to one embodiment;

FIG. 2 illustrates an example packet switching device or component used in one embodiment;

FIG. 3A illustrates a process performed in one embodiment;

FIG. 3B illustrates a process performed in one embodiment;

FIG. 4 illustrates a data structure used in one embodiment; and

FIG. 5 illustrates a process performed in one embodiment; and

FIG. 6 illustrates a message format used in one embodiment.

### DESCRIPTION OF EXAMPLE EMBODIMENTS

### 1. Overview

Disclosed are, inter alia, methods, apparatus, computer-storage media, mechanisms, and means associated with the controlled propagation of virtual local area network (VLAN) declarations. One embodiment includes a packet switching device, comprising a plurality of interfaces communicatively coupled to each other, with each of the plurality of interfaces configured to send and receive packets, the plurality of interfaces including a first interface and a second interface. The packet switching device is configured to propagate virtual local area network (VLAN) declaration information, received on the first interface for a particular VLAN, out the second interface in response to the receipt of VLAN declaration information corresponding to the particular VLAN also being received on the second interface; and wherein the packet switching device is configured not to propagate VLAN declaration information, received on the first interface for the particular VLAN, out the second interface in response to the not receiving VLAN declaration information corresponding to the particular VLAN on the second interface within a predetermined time frame.

### 2. Description

Disclosed are, inter alia, methods, apparatus, computer-storage media, mechanisms, and means associated with the controlled propagation of virtual local area network (VLAN) declarations. Embodiments described herein include various elements and limitations, with no one element or limitation contemplated as being a critical element or limitation. Each of the claims individually recites an aspect of the invention in its entirety. Moreover, some embodiments described may include, but are not limited to, inter alia, systems, networks, integrated circuit chips, embedded processing elements, ASICs, methods, and computer-readable media containing instructions. The embodiments described hereinafter embody various aspects and configurations within the scope and spirit of the invention, with the figures illustrating exemplary and non-limiting configurations. Note, computer-readable media and means for performing methods and processing block operations are disclosed and are in keeping with the extensible scope and spirit of the invention.

Note, the steps, connections, and processing of signals and information illustrated in the figures, including, but not limited to any block and flow diagrams and message sequence charts, may typically be performed in the same or in a different serial or parallel ordering and/or by different components and/or processes, threads, etc., and/or over different connections and be combined with other functions in other embodiments, unless this disables the embodiment or a sequence is explicitly or implicitly required (e.g., for a sequence of read the value, process said read value—the value must be obtained prior to processing it, although some of the associated processing may be performed prior to, concurrently with, and/or after the read operation).

The term “one embodiment” is used herein to reference a particular embodiment, wherein each reference to “one embodiment” may refer to a different embodiment, and the use of the term repeatedly herein in describing associated features, elements and/or limitations does not establish a cumulative set of associated features, elements and/or limitations that each and every embodiment must include, although any embodiment may include some, all or none of the features, elements and/or limitations described in relation to a particular different one embodiment. In addition, the terms “first,” “second,” etc. are typically used herein to denote different units (e.g., a first element, a second element). The use of these terms herein does not necessarily connote an ordering such as one unit or event occurring or coming before another, but rather provides a mechanism to distinguish between particular units. Moreover, the phrases “based on x” and “in response to x” are used to indicate a minimum set of items “x” from which something is derived or caused, wherein “x” is extensible and does not necessarily describe a complete list of items on which the operation is performed, etc. Additionally, the phrase “coupled to” is used to indicate some level of direct or indirect connection between two elements or devices, with the coupling device or devices modifying or not modifying the coupled signal or communicated information. Moreover, the term “or” is used herein to identify a selection of one or more, including all, of the conjunctive items. Additionally, the transitional term “comprising,” which is synonymous with “including,” “containing,” or “characterized by,” is inclusive or open-ended and does not exclude additional, unrecited elements or method steps. Note, nothing described or referenced in this document is admitted as prior art to this application unless explicitly so stated.

Disclosed are, inter alia, methods, apparatus, computer-storage media, mechanisms, and means associated with the controlled propagation of virtual local area network (VLAN) declarations. One embodiment includes a packet switching device, comprising: a plurality of interfaces communicatively coupled to each other, with each of the plurality of interfaces configured to send and receive packets, the plurality of interfaces including a first interface and a second interface; wherein the packet switching device is configured to propagate virtual local area network (VLAN) declaration information, received on the first interface for a particular VLAN, out the second interface in response to the receipt of VLAN declaration information corresponding to the particular VLAN also being received on the second interface; and wherein the packet switching device is configured not to propagate VLAN declaration information, received on the first interface for the particular VLAN, out the second interface in response to the not receiving VLAN declaration information corresponding to the particular VLAN on the second interface within a predetermined time frame.

In one embodiment, said VLAN declaration information is Multiple VLAN Registration Protocol (MVRP) registration information. In one embodiment, wherein the packet switching device is configured to send declaration information out the second interface for only active, and not inactive, VLANs excluding said active VLANs for which VLAN declaration information corresponding to the said active VLAN has not been received on the second interface within a predetermined time frame In one embodiment, the predetermined time frame is measured by not receiving VLAN declaration information on the second interface in response to a predetermined number of LeaveAll messages. In one embodiment, the packet switching device is configured to propagate VLAN declaration information, received on the first interface for the particular VLAN, out the second interface in response to the receipt of VLAN declaration information corresponding to the particular VLAN also being received on the second interface subsequent to not propagating VLAN declaration information, received on the first interface for the particular VLAN, out the second interface in response to the not receiving VLAN declaration information corresponding to the particular VLAN on the second interface within the predetermined time frame. In one embodiment, the plurality of interfaces includes one or more additional interfaces in addition to the first and second interfaces; and wherein the packet switching device is configured for each particular interface of said one or more additional interfaces: to propagate VLAN declaration information, received on the first interface for the particular VLAN, out said particular interface in response to the receipt of VLAN declaration information corresponding to the particular VLAN also being received on the particular interface; and not to propagate VLAN declaration information, received on the first interface for the particular VLAN, out said particular interface in response to the not receiving VLAN declaration information corresponding to the particular VLAN on said particular interface within the predetermined time frame. In one embodiment, the packet switching device includes one or more storage devices for maintaining information for determining whether or not VLAN declaration information has been received within the predetermined time frame for each individual interface of a set of interfaces including the second interface and said one or more additional interfaces.

In one embodiment, the packet switching device is configured to propagate VLAN declaration information, received on the first interface for the particular VLAN, out the second interface in response to the receipt of VLAN declaration information corresponding to the particular VLAN also being received on the second interface subsequent to not propagating VLAN declaration information, received on the first interface for the particular VLAN, out the second interface in response to the not receiving VLAN declaration information corresponding to the particular VLAN on the second interface within the predetermined time frame.

In one embodiment, the plurality of interfaces includes one or more additional interfaces in addition to the first and second interfaces; and wherein the packet switching device is configured for each particular interface of said one or more additional interfaces: to propagate VLAN declaration information, received on the first interface for the particular VLAN, out said particular interface in response to the receipt of VLAN declaration information corresponding to the particular VLAN also being received on the particular interface; and not to propagate VLAN declaration information, received on the first interface for the particular VLAN, out said particular interface in response to the not receiving VLAN declaration information corresponding to the particular VLAN on said particular interface within the predetermined time frame. In one embodiment, the packet switching device includes one or more storage devices for maintaining information for determining whether or not VLAN declaration information has been received within the predetermined time frame for each individual interface of a set of interfaces including the second interface and said one or more additional interfaces.

One embodiment includes a method, comprising: employing a packet switching device to perform operations, the packet switching device including a plurality of interfaces configured to send and receive packets, the plurality of interfaces including a first interface and one or more additional interfaces different than the first interface; and wherein said operations include: maintaining, on a per interface of said one or more additional interfaces basis for each of one or more virtual local area networks (VLANs), information regarding receipt of virtual local area network (VLAN) declaration information received on each of said one or more additional interfaces for each of said one or more VLANs; receiving VLAN declaration information for a first VLAN of said one or more VLANs; and propagating and suppressing propagation of said received VLAN declaration information out each of said one or more additional interfaces according to a determination based on said maintained information for the first VLAN for each particular interface of said one or more additional interfaces; wherein said determination includes: propagating said VLAN declaration for the first VLAN out said particular interface when said maintained information for the first VLAN reflects that declaration information for the first VLAN has been received on the particular interface, and not propagating said VLAN declaration for the first VLAN out said particular interface when said maintained information for the first VLAN reflects that declaration information for the first VLAN has not been received on the particular interface.

In one embodiment, said VLAN declaration information is Multiple VLAN Registration Protocol (MVRP) registration information. One embodiment includes updating said maintained information to reflect whether or not registration information has been received on a specific interface of said one or more additional interfaces for a specific VLAN in response to a LeaveAll message corresponding to the specific VLAN sent out of the specific interface. In one embodiment, said updating said maintained information includes identifying not to propagate received VLAN declaration information for the specified VLAN out the specified interface when VLAN declaration information for the specified VLAN has not been received on the specified interface in response to a predetermined number of LeaveAll messages. In one embodiment, said updating said maintained information includes identifying to propagate received VLAN declaration information for the specified VLAN out the specified interface when VLAN declaration information for the specified VLAN has been received on the specified interface in response to a LeaveAll message. In one embodiment, said propagation of said received VLAN declaration information includes sending a message including declaration information for only active, and not inactive, VLANs of said one or more VLANs excluding said active VLANs for which VLAN declaration information has not been received on said particular interface in response to a predetermined number of LeaveAll messages sent out particular interface. In one embodiment, said propagation of said received VLAN declaration information includes sending a message including declaration information for only active, and not inactive, VLANs of said one or more VLANs excluding said active VLANs for which VLAN declaration information has not been received on said particular interface within a predetermined time frame.

One embodiment includes a packet switching device, comprising: a plurality of interfaces communicatively coupled to each other, with each of the plurality of interfaces configured to send and receive packets; means for maintaining, on a per interface of said the plurality of interfaces basis for each of a plurality of virtual local area networks (VLANs), information regarding receipt of virtual local area network (VLAN) declaration information received on each of said plurality of interfaces for each of said plurality of VLANs; and means for propagating and suppressing propagation of received VLAN declaration information for each of a plurality of active VLANs of the plurality of VLANS out each of the plurality of interfaces according to a determination based on said maintained information for each particular interface of the plurality of interfaces; wherein said determination includes: propagating said VLAN declaration for each said active VLAN out said particular interface when said maintained information for said active VLAN reflects that declaration information for said active VLAN has been received on the particular interface, and not propagating said VLAN declaration for said active VLAN out said particular interface when said maintained information for said active VLAN reflects that declaration information for said active VLAN has not been received on the particular interface.

In one embodiment, said VLAN declaration information is Multiple VLAN Registration Protocol (MVRP) registration information. In one embodiment, said means for maintaining is responsive to LeaveAll messages.

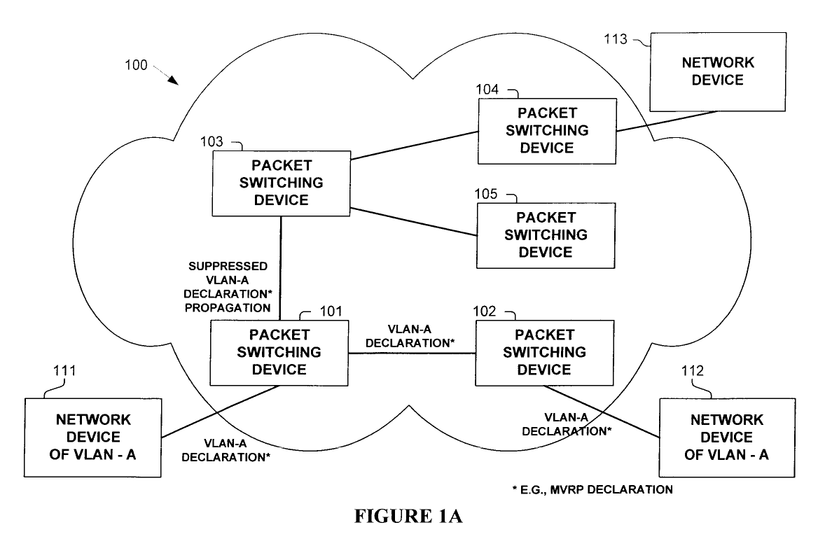

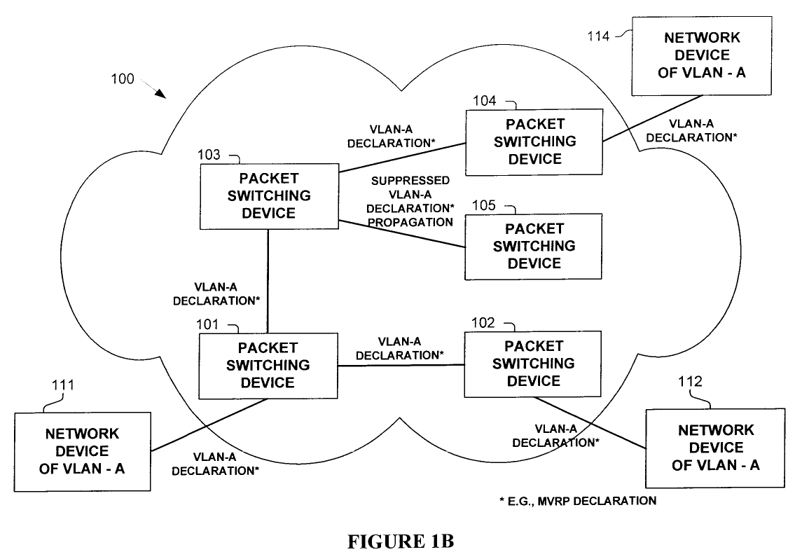

Expressly turning to the figures, FIG. 1A illustrates an example network 100 operating according to one embodiment. Network 100 includes five packet switching devices 101-105 (e.g., switches, routers) communicatively coupled as shown. Coupled to network 100 are three network devices 111-113, with two of these network devices (111-112) participating in VLAN-A. In a prior network, declarations for all VLANs would be distributed to all packet switching devices 101-105.

In one embodiment, such as shown in FIG. 1A, VLAN declarations, such as, but not limited to, those according to Multiple VLAN Registration Protocol (MVRP) are typically communicated in network 100 among packet switching devices (101 and 102) that require the information. The propagation of this information is suppressed, from being sent out interfaces of a packet switching device, to at least certain, if not all, packet switching devices that do not require the information. For example, packet switching device 101 propagates VLAN declaration information received on a first interface for VLAN-A out a second interface to packet switching device 102. Packet switching device 101 also suppresses the propagation (i.e., does not propagate) of this information out a third interface to packet switching device 103, at least after an initial broad or complete distribution of this declaration information.

Note, in one embodiment, the VLAN declaration information is initially propagated throughout network 100, and after some predetermined time frame (which may be adjusted according to the topology of the network), packet switching devices selectively cease to propagate VLAN declaration information out interfaces to packet switching devices which do not require this information. One embodiment determines what VLAN information to distribute out each interface by maintaining information concerning received VLAN declaration information on a per interface per VLAN basis (also considered as being on a per VLAN per interface basis). Therefore, one embodiment selectively propagates (e.g., sends, communicates), and suppresses propagation (e.g., does not send nor communicate), VLAN declaration information out interfaces in order to reduce VLAN declaration information sent out interfaces which does not carry corresponding VLAN traffic.

Turning to FIG. 1B, shown is FIG. 1A modified to replace network device 113 with network device 114 participating in VLAN-A. Therefore, at least after an initial period of a wider distribution of VLAN declaration information for VLAN-A responsive to network device 114 participating in VLAN-A being communicatively attached to packet switching device 114, declaration information for VLAN-A is propagated among packet switching devices 101, 102, 103 and 104, with packet switching device 103 suppresses the propagation of VLAN declaration information out its interface communicatively coupled to packet switching device 105.

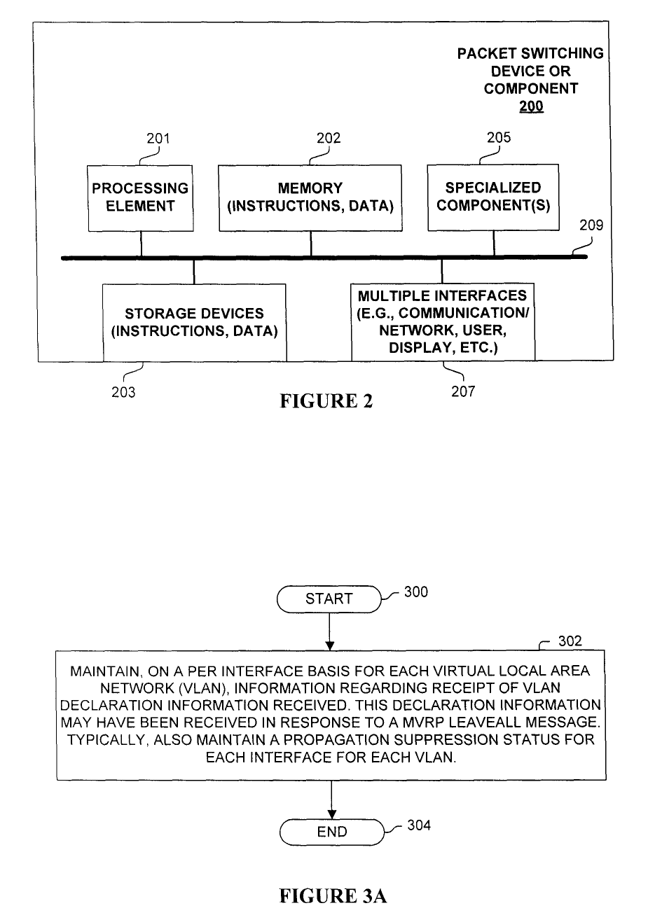

FIG. 2 illustrates an example packet switching device or component 200 (e.g., line card, supervisor or application processor) used in one embodiment. In one embodiment, system or component 200 performs one or more processes or operations thereof, corresponding to one of the flow, block or other diagrams illustrated or otherwise described herein.

In one embodiment, system or component 200 includes a processing element 201, memory 202, storage devices 203, specialized components 205 (e.g. optimized hardware such as for performing lookup operations, maintaining VLAN declaration information, etc.) and interface(s) 207 for communicating information (e.g., sending and receiving packets, user-interfaces, displaying information, etc.), which are typically communicatively coupled via one or more communications mechanisms 209, with the communications paths typically tailored to meet the needs of the application.

Various embodiments of component 200 may include more or less elements. The operation of component 200 is typically controlled by processing element 201 using memory 202 and storage devices 203 to perform one or more tasks or processes. Memory 202 is one type of computer-readable/computer-storage medium, and typically comprises random access memory (RAM), read only memory (ROM), flash memory, integrated circuits, and/or other memory components. Memory 202 typically stores computer-executable instructions to be executed by processing element 201 and/or data which is manipulated by processing element 201 for implementing functionality in accordance with an embodiment. Storage devices 203 are another type of computer-readable medium, and typically comprise solid state storage media, disk drives, diskettes, networked services, tape drives, and other storage devices. Storage devices 203 typically store computer-executable instructions to be executed by processing element 201 and/or data which is manipulated by processing element 201 for implementing functionality in accordance with an embodiment.

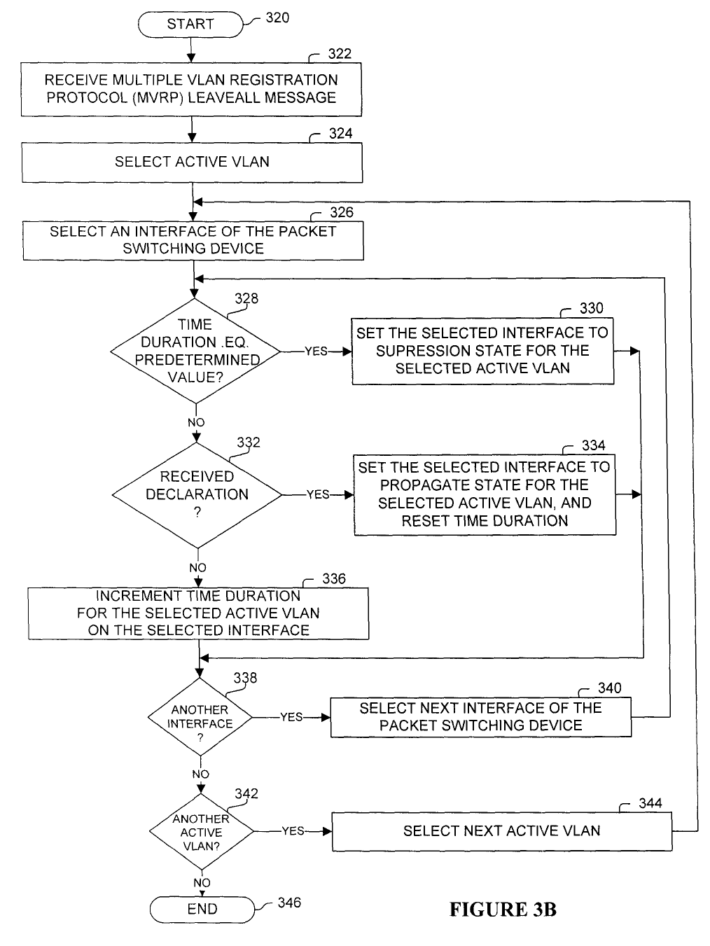

FIG. 3A illustrates a process performed in one embodiment. Processing begins with process block 300, and in process block 302, information is maintained, on a per interface basis for each VLAN, regarding receipt of VLAN declaration information. This declaration information may have been received in response to a Multiple VLAN Registration Protocol (MVRP) LeaveAll Message. Typically, also maintained is a propagation suppression status for each interface for each VLAN for simplicity of operation, although this status may be determined from data maintained in one embodiment. Processing of the flow diagram of FIG. 3A is complete as indicated by process block 304.

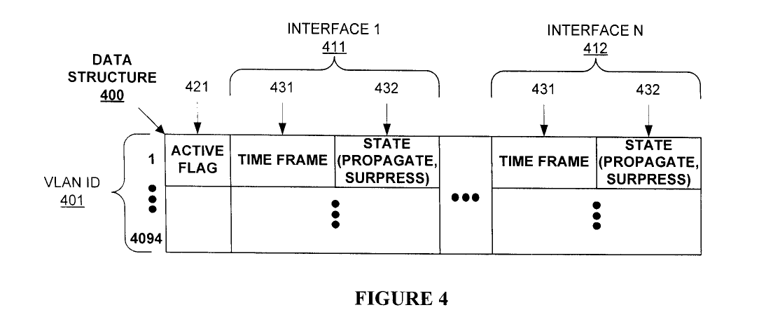

For example, FIG. 4 illustrates a data structure 400, used in one embodiment, for maintaining information on a per VLAN (identified by a VLAN ID) 401, per interface 411-412 basis. Note, illustrated is one set of information maintained, which can be maintained independently or in one or more other data structures typically with other data. Furthermore, the information of data structure 400 may be centrally maintained (e.g., in a processor card, or distributed (e.g., on line and/or processing cards) in a packet switch.

As shown, one embodiment maintains for each VLAN 401 (e.g., VLANs numbered 1-4094), including an active flag 421 identifying whether or not the VLAN is active within the packet switching device. In one embodiment, if the VLAN is not active, declaration information is not maintained nor propagated. In one embodiment, data (431, 432) is also maintained for each VLAN (401) for each interface (411-412) of the packet switching device. Time frame (431) is used to maintain an indication of some amount of time (e.g., duration, number of MVRP LeaveAll message received) relative to the receipt of a VLAN declaration, such as, but not limited to, use for determining whether or not a VLAN declaration was received within a predetermined time frame. State (432) is used to maintain an indication of whether VLAN declarations for the corresponding VLAN (401) for the interface (411-412) should be propagated or suppressed. Note, one embodiment does not use state 432 as it may be determined based on time frame 431 and/or active flag 421.

Next, FIG. 3B illustrates a process, performed in one embodiment, for determining which VLANs and from which interface(s) VLAN declaration information should be propagated or suppressed, such as, but not limited to, in the context of Multiple VLAN Registration Protocol (MVRP). Although the description of this flow diagram uses MVRP messages, corresponding messages or time frames can be equated in other VLAN protocols.

In one embodiment, in response to an MVRP LeaveAll message (which instructs VLAN participants to generate and communication corresponding VLAN declarations), each (active VLAN, interface) pairing is checked to see if the predetermined time frame has expired since a last VLAN declaration for the VLAN has been received on the interface. If so, then the propagation of VLAN declarations for that VLAN will be suppressed from being sent out of that interface. If not, the time duration is updated accordingly. When a VLAN declaration is received for a VLAN on an interface, the corresponding time frame is reset, and the state is set to propagate.

Processing begins with process block 320. In process block 322, a MVRP LeaveAll message is received. For each active VLAN (process block 324 and loop from process block 326 to 344): for each interface of the packet switching device (process block 326 and loop from process block 328 to 340): process blocks 328 to 336 are performed. As determined in process block 328, if the time duration for the (VLAN, interface) is equal to a predetermined value (e.g., a corresponding VLAN declaration has not been received within a predetermined time), then in process block 330, the (VLAN, interface) is set to the suppression state. Otherwise, as determined in process block 332, if a corresponding declaration has been received, then in process block 334, the (VLAN, interface) is set to the propagate state, and its time duration is reset. Otherwise, in process block 336 the corresponding time duration is incremented accordingly.

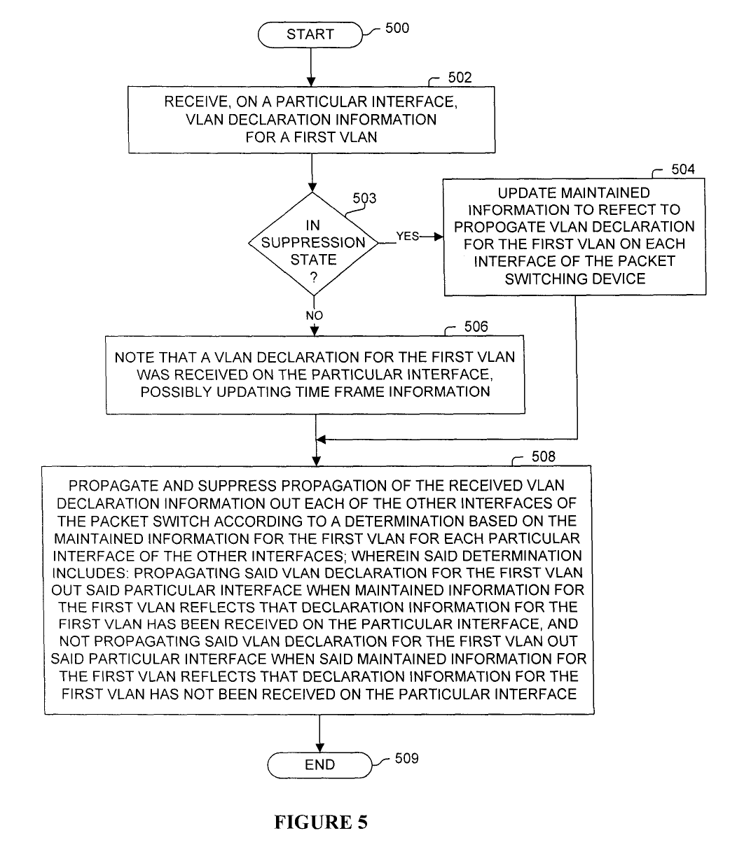

Turning to FIG. 5, illustrated is a process, performed in one embodiment, for updating maintained information and propagating VLAN declaration information in response to a received VLAN declaration on a particular interface. Processing begins with process block 500. In process block 502, VLAN declaration information for a first VLAN is received on a particular interface. As determined in process block 503, if the (VLAN, interface) pair is in the suppression state, then in process block 504, the maintained information is updated to reflect to propagate declaration information out all of the interfaces for the first VLAN. In this way, the VLAN declaration will reach the other participant(s) in the VLAN. (Subsequently, based on the aging of not receiving a VLAN declaration on an interface within a predetermined time frame, that interface will be place in suppression mode, such as, but not limited to, as described in relation to FIG. 3B.) Otherwise, in process block 506, it is noted (possibly for use in process block 332 of FIG. 3B) that a VLAN declaration for the first VLAN was received on the particular interface; and in one embodiment, the corresponding time frame (e.g., 431 of FIG. 4) is reset.

Next, in process block 508: the VLAN declaration information is propagated, or such propagation suppressed, of the received VLAN declaration information out each of the other interfaces of the packet switch according to a determination based on the maintained information for the first VLAN for each particular interface of the other interfaces; wherein said determination includes: propagating said VLAN declaration for the first VLAN out said particular interface when maintained information for the first VLAN reflects that declaration information for the first VLAN has been received on the particular interface, and not propagating said VLAN declaration for the first VLAN out said particular interface when said maintained information for the first VLAN reflects that declaration information for the first VLAN has not been received on the particular interface within a predetermined time frame. Processing of the flow diagram of FIG. 5 is complete as indicated by process block 509.

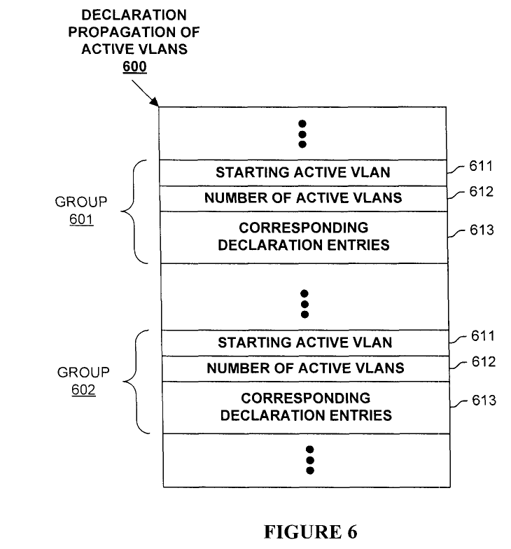

FIG. 6 illustrates message format, used in one embodiment, for propagating VLAN declaration out of an interface of a packet switching device. One embodiment only includes in a VLAN declaration propagation message: VLAN declaration information for active VLANs whose VLAN declaration information has not been suppressed for interface of the packet switching device from which the message is to be sent. Previously, VLAN declaration information for every VLAN was sent in such a VLAN propagation message. Therefore, resources were required to include in these messages VLAN declaration information for all active VLANs (without suppression of such propagation as disclosed herein). Additionally, resources were required to process all of the received information.

As shown in FIG. 6, the VLAN declaration information (600) of one such message includes: one or more groups (601-602) of information related to sequential VLAN IDs. Each group (601-602) defines the starting of the active VLAN ID (611), the number of active VLANs in the group (612), and the corresponding VLAN declaration entries 613. In this manner, only non-suppressed VLAN declaration information for active VLANs are sent (e.g., in contrast to sending VLAN declaration information for every VLAN every time).

In view of the many possible embodiments to which the principles of our invention may be applied, it will be appreciated that the embodiments and aspects thereof described herein with respect to the drawings/figures are only illustrative and should not be taken as limiting the scope of the invention. For example, and as would be apparent to one skilled in the art, many of the process block operations can be re-ordered to be performed before, after, or substantially concurrent with other operations. Also, many different forms of data structures could be used in various embodiments. The invention as described herein contemplates all such embodiments as may come within the scope of the following claims and equivalents thereof.

What is claimed is:

1. A packet switching device, comprising:
a plurality of interfaces communicatively coupled to each other, with each of the plurality of interfaces configured to send and receive packets, the plurality of interfaces including a first interface and a second interface;
wherein the packet switching device is configured to propagate virtual local area network (VLAN) declaration information, received on the first interface for a particular VLAN, out the second interface in response to the receipt of VLAN declaration information corresponding to the particular VLAN also being received on the second interface; and wherein the packet switching device is configured not to propagate VLAN declaration information, received on the first interface for the particular VLAN, out the second interface in response to the not receiving VLAN declaration information corresponding to the particular VLAN on the second interface within a predetermined time frame.

2. The packet switching device of claim 1, wherein said VLAN declaration information is Multiple VLAN Registration Protocol (MVRP) registration information.

3. The packet switching device of claim 2, wherein the packet switching device is configured to send declaration information out the second interface for only active, and not inactive, VLANs excluding said active VLANs for which VLAN declaration information corresponding to the said active VLAN has not been received on the second interface within a predetermined time frame

4. The packet switching device of claim 2, wherein the predetermined time frame is measured by not receiving VLAN declaration information on the second interface in response to a predetermined number of LeaveAll messages.

5. The packet switching device of claim 4, wherein the packet switching device is configured to propagate VLAN declaration information, received on the first interface for the particular VLAN, out the second interface in response to the receipt of VLAN declaration information corresponding to the particular VLAN also being received on the second interface subsequent to not propagating VLAN declaration information, received on the first interface for the particular VLAN, out the second interface in response to the not receiving VLAN declaration information corresponding to the particular VLAN on the second interface within the predetermined time frame.

6. The packet switching device of claim 5, wherein the plurality of interfaces includes one or more additional interfaces in addition to the first and second interfaces; and
wherein the packet switching device is configured for each particular interface of said one or more additional interfaces:
to propagate VLAN declaration information, received on the first interface for the particular VLAN, out said particular interface in response to the receipt of VLAN declaration information corresponding to the particular VLAN also being received on the particular interface; and
not to propagate VLAN declaration information, received on the first interface for the particular VLAN, out said particular interface in response to the not receiving VLAN declaration information corresponding to the particular VLAN on said particular interface within the predetermined time frame.

7. The packet switching device of claim 6, wherein the packet switching device includes one or more storage devices for maintaining information for determining whether or not VLAN declaration information has been received within the predetermined time frame for each individual interface of a set of interfaces including the second interface and said one or more additional interfaces.

8. The packet switching device of claim 1, wherein the packet switching device is configured to propagate VLAN declaration information, received on the first interface for the particular VLAN, out the second interface in response to the receipt of VLAN declaration information corresponding to the particular VLAN also being received on the second interface subsequent to not propagating VLAN declaration information, received on the first interface for the particular VLAN, out the second interface in response to the not receiving VLAN declaration information corresponding to the particular VLAN on the second interface within the predetermined time frame.

9. The packet switching device of claim 1, wherein the plurality of interfaces includes one or more additional interfaces in addition to the first and second interfaces; and
wherein the packet switching device is configured for each particular interface of said one or more additional interfaces:
to propagate VLAN declaration information, received on the first interface for the particular VLAN, out said particular interface in response to the receipt of VLAN declaration information corresponding to the particular VLAN also being received on the particular interface; and
not to propagate VLAN declaration information, received on the first interface for the particular VLAN, out said particular interface in response to the not receiving VLAN declaration information corresponding to the particular VLAN on said particular interface within the predetermined time frame.

10. The packet switching device of claim 9, wherein the packet switching device includes one or more storage devices for maintaining information for determining whether or not VLAN declaration information has been received within the predetermined time frame for each individual interface of a set of interfaces including the second interface and said one or more additional interfaces.

11. A method, comprising:
employing a packet switching device to perform operations, the packet switching device including a plurality of interfaces configured to send and receive packets, the plurality of interfaces including a first interface and one or more additional interfaces different than the first interface; and wherein said operations include:
maintaining, on a per interface of said one or more additional interfaces basis for each of one or more virtual local area networks (VLANs), information regarding receipt of virtual local area network (VLAN) declaration information received on each of said one or more additional interfaces for each of said one or more VLANs;
receiving VLAN declaration information for a first VLAN of said one or more VLANs; and
propagating and suppressing propagation of said received VLAN declaration information out each of said one or more additional interfaces according to a determination based on said maintained information for the first VLAN for each particular interface of said one or more additional interfaces; wherein said determination includes: propagating said VLAN declaration for the first VLAN out said particular interface when said maintained information for the first VLAN reflects that declaration information for the first VLAN has been received on the particular interface, and not propagating said VLAN declaration for the first VLAN out said particular interface when said maintained information for the first VLAN reflects that declaration information for the first VLAN has not been received on the particular interface.

12. The method of claim 11, wherein said VLAN declaration information is Multiple VLAN Registration Protocol (MVRP) registration information.

13. The method of claim 12, including updating said maintained information to reflect whether or not registration information has been received on a specific interface of said one or more additional interfaces for a specific VLAN in response to a LeaveAll message corresponding to the specific VLAN sent out of the specific interface.

14. The method of claim 13, wherein said updating said maintained information includes identifying not to propagate received VLAN declaration information for the specified VLAN out the specified interface when VLAN declaration information for the specified VLAN has not been received on the specified interface in response to a predetermined number of LeaveAll messages.

15. The method of claim 14, wherein said updating said maintained information includes identifying to propagate received VLAN declaration information for the specified VLAN out the specified interface when VLAN declaration information for the specified VLAN has been received on the specified interface in response to a LeaveAll message.

16. The method of claim 13, wherein said propagation of said received VLAN declaration information includes sending a message including declaration information for only active, and not inactive, VLANs of said one or more VLANs excluding said active VLANs for which VLAN declaration information has not been received on said particular interface in response to a predetermined number of LeaveAll messages sent out particular interface.

17. The method of claim 12, wherein said propagation of said received VLAN declaration information includes sending a message including declaration information for only active, and not inactive, VLANs of said one or more VLANs excluding said active VLANs for which VLAN declaration information has not been received on said particular interface within a predetermined time frame.

18. A packet switching device, comprising:
a plurality of interfaces communicatively coupled to each other, with each of the plurality of interfaces configured to send and receive packets;
means for maintaining, on a per interface of said the plurality of interfaces basis for each of a plurality of virtual local area networks (VLANs), information regarding receipt of virtual local area network (VLAN) declaration information received on each of said plurality of interfaces for each of said plurality of VLANs; and
means for propagating and suppressing propagation of received VLAN declaration information for each of a plurality of active VLANs of the plurality of VLANS out each of the plurality of interfaces according to a determination based on said maintained information for each particular interface of the plurality of interfaces; wherein said determination includes: propagating said VLAN declaration for each said active VLAN out said particular interface when said maintained information for said active VLAN reflects that declaration information for said active VLAN has been received on the particular interface, and not propagating said VLAN declaration for said active VLAN out said particular interface when said maintained information for said active VLAN reflects that declaration information for said active VLAN has not been received on the particular interface.

19. The packet switching device of claim 18, wherein said VLAN declaration information is Multiple VLAN Registration Protocol (MVRP) registration information.

20. The packet switching device of claim 18, wherein said means for maintaining is responsive to LeaveAll messages.
